(19) United States
(12) Patent Application Publication
(10) Pub. No.: US 2026/0298798 A1
(43) Pub. Date: Oct. 1, 2026

(54) CORROSION TESTING SYSTEM

(71) Applicant: Saudi Arabian Oil Company, Dhahran (SA)

(72) Inventors: Mustafa M. Alsalem, Riyadh (SA); Zahrah S. Altarooti, Tarout (SA); Ali A. Jabran, Dammam (SA); Hassan Al Tarouti, Qatif (SA)

(21) Appl. No.: 19/097,397

(22) Filed: Apr. 1, 2025

(51) Int. Cl. G01N 17/00

(52) U.S. Cl. CPC G01N 17/002

(57) ABSTRACT

An automated corrosion testing system includes a conditioning vessel at least partially enclosing a first interior volume, a conditioning vessel lid configured to connect to the conditioning vessel and seal the conditioning vessel, a reaction vessel at least partially enclosing a second interior volume, a reaction vessel lid configured to connect to the reaction vessel and seal the reaction vessel, and a fluid transfer line fluidly connecting the conditioning vessel to the reaction vessel. The fluid transfer line guides a flow of a fluid from the conditioning vessel to the reaction vessel. The testing system also includes a sealing system including a locking device to couple the reaction vessel lid to the reaction vessel, and a control system communicably connected to the sealing system and the fluid transfer line. The control system activates the sealing system and controls the flow of fluid through the fluid transfer line.

### TECHNICAL FIELD

This disclosure relates to corrosion testing, and more particularly to automated corrosion testing systems and methods.

### BACKGROUND

Material corrosion occurs through exposure to various corrosive fluids or other corrosive materials. Laboratory testing simulates material corrosion in a controlled environment. Batch autoclave reactors are usually employed for corrosion related studies, such as corrosivity assessment and material selection. Autoclave reactors are operated manually through a sequence of corrosivity testing steps.

### SUMMARY

This disclosure describes corrosion testing.

In some aspects, an example automated corrosion testing system includes a conditioning vessel at least partially enclosing a first interior volume, a conditioning vessel lid connected to the conditioning vessel to seal the conditioning vessel, a reaction vessel at least partially enclosing a second interior volume, a reaction vessel lid connected to the reaction vessel to seal the reaction vessel, and a fluid transfer line fluidly connecting the conditioning vessel to the reaction vessel. The fluid transfer line guides a flow of a fluid from the conditioning vessel to the reaction vessel, and a sealing system including a locking device couples the reaction vessel lid to the reaction vessel. A control system communicably connected to the sealing system and the fluid transfer line activates the sealing system and controls the flow of fluid through the fluid transfer line.

Certain aspects of the disclosure encompass a method for corrosion testing a material, including receiving a brine solution in a conditioning vessel, supporting a testing material on a shaft within a reaction vessel, sealing a reaction vessel lid to the reaction vessel with a locking device of a sealing system in response to a command from a control system, where the control system is communicably connected to the sealing system to control the locking device, and guiding the brine solution from the conditioning vessel to the reaction vessel with a fluid transfer line fluidly connecting the conditioning vessel and the reaction vessel.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic system diagram of an example corrosion testing system.

FIG. 2 is a schematic front view of an example sealing system that can be used in the example corrosion testing system of FIG. 1.

FIG. 3 is a partial schematic perspective view of an example primary electrode that can be used in the example corrosion testing system of FIG. 1.

FIG. 4 is a flowchart describing an example method for corrosion testing a material.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

This disclosure describes corrosion testing systems and methods that are partially or completely automated, for example, to conduct corrosion studies in an accelerated and robust manner. An example automated smart corrosion testing system for corrosivity assessment of materials includes a conditioning vessel for preparation of a brine and a reaction vessel for corrosion testing a material(s). The reaction vessel and conditioning vessel are fluidly connected by a fluid transfer line for automated or otherwise controlled flow of fluid from the conditioning vessel to the reaction vessel in preparation for a testing operation. The testing system also includes an automated sealing system for sealing one or both of the conditioning vessel or the reaction vessel during operation. A control system controls the preparation of the conditioning vessel and reaction vessel, the flow of brine components into the conditioning vessel, the flow of fluid between the conditioning vessel and the reaction vessel, the control of fluid flow, pH level, temperature, and other characteristics of fluid in the reaction vessel, or a combination of these features.

In some conventional corrosion testing systems, such as in batch autoclave reactors for corrosion analysis, the reactors are operated manually throughout corrosion testing operations, such as through laborious steps including sealing and pressure testing the reactor(s), preparing gas and liquid phases for introduction to the reactor(s), introducing corroding substrates to corrosive media, and disposing of hazardous waste materials following termination of a corrosion testing sequence. These manual steps are labor intensive, and require experimental procedures and strict safety practices, for example, due to use of hazardous acid gases (for example, hydrogen sulfide gas) in corrosivity assessments. Also, batch reactors often lack robust, reactive internal monitoring techniques to track and correct for changes in chemistry of the liquid or gas phases, as corrosion experiments can extend for prolonged test durations, such as hours, days, weeks, or months. In the present disclosure, an example corrosion testing system is partially or fully automated, smart, and utilizes digitalization and automation to operate and control steps of a corrosion testing operation with little to no manual labor steps. For example, high pressure high temperature (HPHT) corrosion studies can be carried out with an automated corrosion testing system in an accelerated and robust manner to improve safety protocols, elevate the accuracy of corrosivity assessment, reduce manhours required to perform corrosion assessments, or a combination of these. In some implementations, an automated corrosion testing system can be integrated with a set of automated processes and algorithms for controlling operations of the system, including the preparation of a liquid phase brine, conditioning the brine, closure and pressure testing of vessels, conditioning a gas phase, heating, cooling, characteristic estimation (such as wall shear stress and corresponding rotation), controlling solution pH, termination and depressurization cleaning and conditioning the vessels, a combination of these, or other corrosion testing operations.

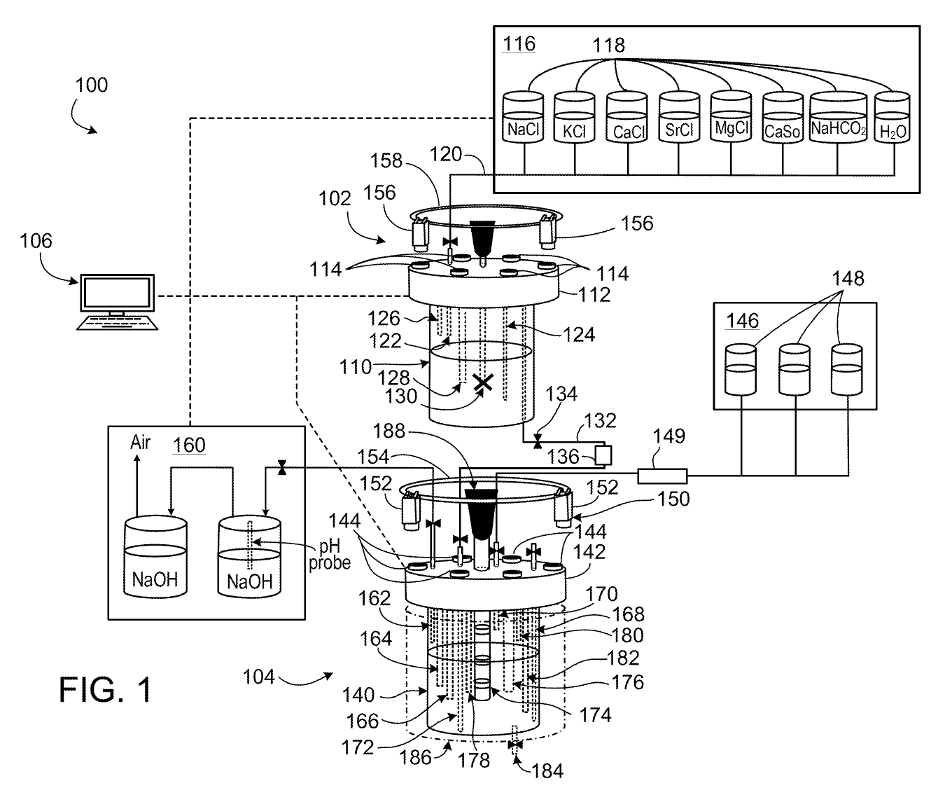

FIG. 1 is a schematic system diagram of an example corrosion testing system 100. The example corrosion testing system 100 includes a conditioning assembly 102, a reaction assembly 104, and a control system 106 for controlling operation of the components of the example corrosion testing system 100. The conditioning assembly 102 generates and prepares a brine solution for use in a testing operation, the reaction assembly 104 performs testing operations on a testing material using the prepared brine solution from the conditioning assembly 102, and the control system 106 controls operation of some or all components of the conditioning assembly 102, reaction assembly 104, or both, during a testing operation with limited or no manual intervention by a user other than placing a testing material or coupon in the reaction assembly 104. For example, the control system 106 is communicably connected to the conditioning assembly 102 and to the reaction assembly 104 to initiate certain testing operations, compile data from sensors, gauges, valves, and other components, determine adjustments to the testing operations based on the compiled data, and control operation of valves, pumps, motors, and other components of the example corrosion testing system 100 to operate as partially or completely automated. In some instances, the control system 106 automates and monitors a complete testing operation based on input parameters from a user, such as a test environment characteristics and specifications, and following the placement of a testing material or coupon. These characteristics and specifications can include a temperature, total pressure, gas composition, brine composition, bulk solution pH, test duration, rotation speed, type of material to be tested, electrochemical test parameters, a combination of these parameters, or other parameters. In the example corrosion testing system 100 of FIG. 1, the control system 106 includes a user interface, for example, for the user to enter and confirm the input parameters and initiate a testing operation.

The conditioning system 102 includes a conditioning vessel 110 partially enclosing an interior volume of the conditioning vessel 110, and a conditioning vessel lid 112 shaped to attach to the conditioning vessel 110 (for example, at an open top end of the conditioning vessel 110) and seal the interior volume of the conditioning vessel 110. The conditioning vessel lid 112 engages the conditioning vessel 110 to provide a pressure-tight seal, for example, such that the conditioning vessel 110 and conditioning vessel lid 112 form an airtight seal of the interior volume. The conditioning vessel lid 112 connects to the conditioning vessel 110 with fasteners 114, for example, bolt fasteners or other types of fasteners, for securely connecting the conditioning vessel lid 112 to the conditioning vessel 110. The conditioning vessel lid 112 is removable from the conditioning vessel 110, for example, by unfastening the fasteners 114 and separating the conditioning vessel lid 112 from the conditioning vessel 110. In the example conditioning system 102, the conditioning vessel 110 is cylindrical, and the conditioning vessel lid 112 has a corresponding circular profile to engage with the conditioning vessel 110. However, the conditioning vessel 110, the conditioning vessel lid 112, or both, can form other shapes, such as a rectangular shape or other forms.

The conditioning system 102 also includes a brine makeup system 116 fluidly connected to the conditioning vessel 110 and communicably connected to the control system 106. The brine makeup system 116 includes multiple vessels 118 that individually hold compositions (such as fluid compositions, powders, or salts) that, when combined in a specified combination and concentration, form a desired brine solution. The brine makeup system 116 can include multiple controllable valves fluidly connected between the vessels 118 and a brine tubing 120 that allow for the flow of a composition from one or more or all of the fluid vessels 118 to the brine tubing 120 leading to the conditioning vessel 110. In preparation for a testing operation of the examine testing system 100, the conditioning vessel 110 receives a brine solution from the brine makeup system 116 made up a specified combination of compositions from one or more of the vessels of the brine makeup system 116. In some implementations, the fluid vessels 118 can contain sodium chloride (NaCl), potassium chloride (KCl), calcium chloride (CaCl), strontium chloride (SrCl), magnesium chloride (MgCl), calcium sulfate (CaSO), sodium bicarbonate (NaHCO₂), deionized water, a combination of these, or other compounds.

The brine tubing 120 fluidly connects the brine makeup system 116 to the interior volume of the conditioning vessel 110, for example, through a conduit in the conditioning vessel lid 112. A valve, pump, or other flow control device can be disposed in the brine tubing 120 to control a flow of a brine solution from the brine makeup system 116 to the conditioning vessel 110, and to seal the brine tubing 120, for example, in instances where the interior volume of the conditioning vessel 110 undergoes other testing operations, such as a purging or cleaning of the conditioning vessel 110, described in greater detail later.

In some implementations, the conditioning vessel lid 112, the conditioning vessel 110, or both the lid 112 and the vessel 110, are equipped with one or more sensors, fluid inlets, fluid outlets, or other components for interacting with the interior volume or the contents within the interior volume of the conditioning vessel 110. For example, the conditioning vessel lid 112 includes a brine solution inlet 122, gas inlet 124, gas outlet 126, oxygen probe 128, and a fluid mixer 130 disposed in the interior volume of the conditioning vessel 110. One or more or all of these components are communicably connected to the control system 106, for example, for automatic control via commands from the control system 106.

The reaction system 104 includes a reaction vessel 140 partially enclosing an interior volume of the reaction vessel 140, and a reaction vessel lid 142 shaped to attach to the reaction vessel 140 (for example, at an open top end of the reaction vessel 140) and seal the interior volume of the reaction vessel 140. The reaction vessel lid 142 engages the reaction vessel 140 to provide a pressure-tight seal, for example, such that the reaction vessel 140 and reaction vessel lid 142 form an airtight seal of the interior volume. The reaction vessel lid 142 connects to the reaction vessel 140 with fasteners 144, for example, bolt fasteners or other types of fasteners, for securely connecting the reaction vessel lid 142 to the reaction vessel 140. The reaction vessel lid 142 is removable from the reaction vessel 140, for example, by unfastening the fasteners 144 and separating the reaction vessel lid 142 from the reaction vessel 140. In the example reaction system 104, the reaction vessel 140 is cylindrical, and the reaction vessel lid 142 has a corresponding circular profile to engage with the reaction vessel 140. However, the reaction vessel 140, the reaction vessel lid 142, or both, can form other shapes, such as a rectangular shape or other forms.

The example corrosion testing system 100 includes a fluid transfer line 132, such as a tubing or piping, that fluidly connects the conditioning vessel 110 to the reaction vessel 140. The fluid transfer line 132 guides a flow of a fluid, such as a brine solution, from the conditioning vessel 110 to the reaction vessel 140 in preparation for a corrosivity testing operation in the reaction vessel 140. In some instances, the fluid transfer line 132 includes one or more flow control valves 134 (two shown) to control a flow of the fluid from the conditioning vessel 110 to the reaction vessel 140, and to seal the fluid transfer line 132 in instances where the interior volume of the reaction vessel 140 undergoes testing operations where the reaction vessel 140 needs to be pressure sealed. The flow control valve(s) 134 are communicably connected to the control system 106, for example, such that the control system 106 can control the flow of the fluid into the reaction vessel 140. In some implementations, the fluid transfer line 132 includes a pump 136 along the fluid transfer line 132 to bias flow of the fluid from the conditioning vessel 110 to the reaction vessel 140. The control system 106 can also control operation of the pump 136. In certain implementations, the pump 136 is excluded from the fluid transfer line 132. For example, the conditioning vessel 110 can be positioned vertically higher than the reaction vessel 140, and gravity can bias the flow of fluid through the fluid transfer line 132 from the conditioning vessel 110 to the reaction vessel 140.

The example corrosion testing system 100 also includes a sealing system 150 for coupling the reaction vessel lid 142 to the reaction vessel 140. In the example corrosion testing system 100 of FIG. 1, the sealing system 150 includes one or more locking devices 152 (two shown) supported on a railway 154 adjacent to the reaction vessel lid 142. In some implementations, the railway 154 has a shape that generally follows the pattern of fasteners 144 on the reaction vessel lid 142, and the locking devices 152 can translate along the railway 154 to engage with the fasteners 144 and securely fasten or unfasten the fasteners 144. In some instances, the locking devices 152 are bolt fasteners with a key link corresponding to a profile of the fasteners 144, such that the key link can engage and torque the fasteners 144 in a fastening or unfastening direction.

In some implementations, the sealing system 150 includes a second locking device 156 (two shown) supported on a second railway 158 adjacent to the conditioning vessel lid 112. In some implementations, the second railway 158 has a shape that generally follows the pattern of fasteners 114 on the conditioning vessel lid 112, and the second locking device(s) 156 can translate along the second railway 158 to engage with the fasteners 114 and securely fasten or unfasten the fasteners 114. In some instances, the second locking devices 156 are bolt fasteners with a key link corresponding to a profile of the fasteners 114, such that the key link can engage and torque the fasteners 114 in a fastening or unfastening direction.

The control system 106 can communicate with and control the sealing system 150, for example, to control operation of the locking devices 152, second locking devices 156, or both, to selectively fasten and seal or unfasten and unseal the reaction vessel lid 142, the conditioning vessel lid 112, or both.

The reaction system 104 also includes a pH adjustment system 146 fluidly connected to the reaction vessel 140 and communicably connected to the control system 106. The pH adjustment system 146 includes fluid vessels 148 that hold different pH altering compositions, such as an acid, a base, a chemical injection fluid, or a combination of these. The pH adjustment system 146 can also include multiple controllable valves fluidly connected between the vessels 148 and the reaction vessel 140 that allow for the flow of a fluid from one or more or all of the fluid vessels 148 to a tubing leading to the reaction vessel 140. For example, during a testing operation, the pH adjustment system 146 can automatically adjust a pH level in the reaction vessel 140 by adding a fluid from one or more of the vessels 148 into the reaction vessel 140. In some implementation, as a reaction occurs inside the reaction vessel 140, the pH of the fluid in the reaction vessel 140 is expected to drift with time due to corrosion, product precipitation, and consumption of reactants. As such, an acid or base (or a combination of both) can be introduced into the reaction vessel 140 from the designated storage vessels 148 to restore and maintain a pH in the reaction vessel 140. In some examples, the tubing between the pH adjustment system 146 and the reaction vessel 140 includes a flow control device 149, such as a fluid pump or solenoid valve, to control the flow of fluid from the pH adjustment system 146 to the reaction vessel 140.

The reaction system 104 also includes a gas discharge system 160 fluidly connected to the reaction vessel 140 and communicably connected to the control system 106 to receive a discharged gas from the reaction vessel 140, for example, following the completion of a corrosion testing operation. The gas discharge system 160 can include a scrubber to filter the discharged gas from the reaction vessel 140.

In some implementations, the reaction vessel lid 142, the reaction vessel 140, or both the lid 142 and the vessel 140, are equipped with one or more sensors, fluid inlets, fluid outlets, or other components for interacting with the interior volume or the contents within the interior volume of the reaction vessel 140. For example, the reaction vessel lid 142 includes a gas outlet 162 (for example, leading to the gas discharge system 160), a pH probe 164, an oxygen probe 166, a gas inlet 168, a pH balancing feed inlet 170 (for example, from the pH adjustment system 146), a transfer line 172 (for example, from the fluid transfer line 132), a primary electrode 174, a counter electrode 176, a reference electrode 178, a gas phase thermocouple 180, a liquid phase thermocouple 182, a drain vent 184, or a combination of these. One or more or all of these components are communicably connected to the control system 106, for example, for automatic control via commands from the control system 106. In some implementations, the reaction vessel 140 is equipped with a heat jacket at least partially surrounding the reaction vessel 140 and communicably connected to the control system 106. The heat jacket acts to increase a temperature of a fluid within the reaction vessel 140, for example, by heating the reaction vessel 140 itself. A temperature sensor within the reaction vessel 140 can determine a temperature of the fluid, and the control system 106 can control the heat jacket 186 to bias the fluid to a desired temperature.

The primary electrode 174, or working electrode, is supported by the reaction vessel lid 142 at or near a center of the reaction vessel 140. The primary electrode 174 includes a cylindrical shaft that supports a testing material within the reaction vessel 140, where the testing material is to be analyzed with a corrosion testing operation. In some implementations, the testing material is in the form of a coupon that can be inserted and mounted on the shaft of the primary electrode 174. The coupon can be a metal sample with known characteristics, such as chemical composition, appearance, density, size, and weight, and the coupon is used as replaceable material samples on the shaft, or primary electrode 174. The coupon can correlate to material of interest that is to be evaluated inside the reaction vessel 140 under a certain set of conditions, such as under a specified temperature, pressure, and rotational velocity. In some implementations, the coupons, or samples, are metallic materials tested inside the reaction vessel 140 to study their corrosion behavior under simulated field conditions observed in surface and sub-surface facilities, such as in a downhole wellbore. In some implementations, the shaft of the primary electrode 174 is rotatable. For example, a magnetic drive motor 188 can connect to the primary electrode 174 to drive rotation of the shaft during a testing operation.

The example corrosion testing system 100 of FIG. 1 can be automatically operated and controlled to perform a complete corrosivity test. In an example implementation, the corrosion testing system 100 can undergo several different modes facilitated by automation and digitalization: ready mode, test initiation, test in progress, test termination, cleaning mode, and emergency shutdown.

In the ready mode, the example corrosion testing system 100 is clean and unsealed. The reaction vessel 140 is lowered relative to the reaction vessel lid 142, and a central shaft on the primary electrode 174 is exposed for installation of one or more coupons.

During test initiation, a brine from the brine makeup system 116 is prepared and flows to the conditioning vessel 110. This entails adding a specified amount of one or more or all salt solutions and deionized water in the vessels 118. The specified brine solution can be representative of a specified environment, such as a downhole wellbore condition. The brine solution is prepared utilizing pre-prepared solutions of salts mimicking the brine composition observed in a variety of environments, including that of a downhole environment. Subsequently, the brine solution in the conditioning vessel 110 undergoes deoxygenation through a continuous purging of nitrogen gas through the conditioning vessel 110 for a minimum time, such as for one hour. The oxygen content in the conditioning vessel 110 is monitored though the oxygen probe 128. The purging continues until the oxygen content is less than 5 parts per million (ppm). The introduction of nitrogen through the gas inlet 124 can physically displace the oxygen present in the conditioning vessel 110 and remove the presence of oxygen in the solution through the gas outlet 126. This purging process can be improved with nitrogen introduced at a high flow rate, which can agitate the brine solution inside the conditioning vessel 110.

While the brine solution is being prepared in the conditioning vessel 110, a pressure test can be performed on the reaction vessel 140 and its associated accessories. Raising and lowering of the reaction vessel 140 relative to the reaction vessel lid 142 can be performed automatically, for example, in response to a command from the control system 106. The pressure test includes sealing the reaction vessel 140 and the reaction vessel lid 142 with the sealing system 150, pressurizing the reaction vessel 140 with nitrogen gas through the gas inlet 168 to a pressure that is 5% to 10% higher than a targeted test pressure. If the reaction vessel 140 does not experience any leaks during the pressure test, the gas in the reaction vessel 140 is released through the gas outlet 162 until the interior space of the reaction vessel 140 reaches atmospheric pressure. In preparation for the transfer of the brine solution from the conditioning vessel 110 to the reaction vessel 140, the control system 106 can monitor the oxygen content inside the reaction vessel 140 with the oxygen probe 166. If needed, the reaction vessel 140 can be purged with nitrogen gas until its oxygen content is near zero, such as less than 10 parts per billion (ppb). Once the conditioning is complete and the reaction vessel 140 is depressurized and deoxygenated, the brine solution is transferred into the reaction vessel 140 through the fluid transfer line 132, ensuring continuous purging of nitrogen gas throughout the conditioning vessel 110 and the reaction vessel 140. Subsequently, the fluid transfer line 132 can be automatically sealed and additional system functions are initiated. These system functions can include initiation of the rotation of the shaft, powering of the heat jacket 186, and nitrogen gas can continue to be purged through the reaction vessel 140, for example, for at least 10 minutes before a complete sealing of the reaction vessel 140. Once a desired temperature of the fluid in the reaction vessel 140 has been reached, gases can be added to the reaction vessel 140 per a specified gas composition specified by a user. These gases can include nitrogen, argon, methane, hydrogen sulfide, carbon dioxide, a combination of these gases, or other gases. The gases can be introduced to the reaction vessel 140 based on their pressure inside a respective gas cylinder; however, a compressor can also be used to increase pressure to the added gases, if needed.

During a test in progress, the control system 106 continuously monitors and records trackable variables, such as characteristics of the fluid in the reaction vessel 140. These characteristics can include, temperature, pressure, near surface pH, bulk solution pH, oxygen content, a combination of these, or other characteristics. In some implementations, a desired electrochemical testing technique can be performed.

During the test in progress, the pH adjustment system 146 is controlled based on a determined pH of the reaction vessel 140, such as from a reading from the pH probe 164 disposed within the fluid solution. In some examples, the control system 106 determines a shift in the pH level of the fluid, such as a shift greater than 0.3 pH, and is remedied using the pH adjustment system 146. For example, a decrease in pH can be corrected by spraying a droplet of a caustic solution available in the pH adjustment system 146, and the pH reading is monitored for a few minutes to ensure stabilization. If the pH continues to deviate from a specified target pH value, another droplet of the solution from the pH adjustment system 146 can be sprayed into the reaction vessel 140. Similarly, for example, an increase in pH can be corrected by spraying an acidic solution available in the pH adjustment system 146, and the pH reading is monitored for a period of time to ensure pH stabilization.

At the conclusion of a testing operation, a test termination phase is initiated. For example, once a set duration of the test has concluded, test termination beings with the shutdown of the heat jacket 186. The fluid in the reaction vessel 140 can cool down using a fluid-based temperature control system, such as to a temperature of 40 degrees Celsius (° C). Once the desired temperature is attained, the reaction vessel 140 is slowly depressurized through the gas discharge system 160. After the reaction vessel 140 is depressurized, nitrogen gas is purged through the reaction vessel 140, for example, to ensure removal of all acidic gases. The purging can continue for a minimum period of time such as for two hours or more. During this purging , the pH of the gas flowing through the gas discharge system 160 can be monitored to maintain and ensure scrubbing efficiency of the discharged gas. Subsequently, the fluid solution remaining in the reaction vessel 140 can be drained through the drain vent 184 located at the bottom of the reaction vessel 140. The reaction vessel 140 is then unsealed and separated from the reaction vessel lid 142 for retrieval of the coupon(s).

During a cleaning mode of the example corrosion testing system 100, the conditioning vessel 110 and reaction vessel 140 are automatically sealed to their respective vessel lids, and the conditioning vessel 110 is filled and flushed with water. This flush can be cycled, such as for a minimum of three times. During this flushing process, the water can pass from the conditioning vessel 110 through the fluid transfer line 132 and to the reaction vessel 140 before being drained. Once the conditioning vessel 110 has been thoroughly cleaned, the reaction vessel 140 can be automatically sealed and filled with water. The heat jacket 186 is then powered and set to a temperature of 10° C. higher than that of the terminated test. The example system 100 shall be left for a period of time (for example, an hour) to ensure the dissolution of most contaminants and precipitates in the reaction vessel 140. The temperature is then decreased to 80° C. with the temperature control system, and any water or other fluids in the reaction vessel 140 is drained. To ensure the proper cleaning of the reaction vessel 140, an acid can be sprayed from a nozzle of the pH adjustment system 146 into the reaction vessel 140, and the acid spray is followed by spraying of water, caustic, then water again. This cycle can be repeated three times or more for sufficient cleaning of the reaction vessel 140.

In some instances, the example corrosion testing system 100 can perform an emergency shutdown operation during a testing operation. In the case of an emergency, the example corrosion testing system 100 stops all functions and enters a test termination mode.

The modes of operation of the example corrosion testing system 100 can be partially or fully integrated within the control system 106. In some implementations, the example corrosion testing system 100 starts at ready mode, and an operator initiates a testing operation by inputting test parameters into the control system 106. For example, a user can mount one or more coupons into the shaft, then feed the control system 106 with test parameters to establish a test environment and test specifications. These parameters can include temperature, total pressure, gas composition, brine composition, bulk solution pH, test duration, rotational speed, type of material to be tested, an electrochemical test, a combination of these, or additional parameters. The user can confirm the inputs and initiate the test using an interface of the control system 106. Subsequently, the sealing system 150 can be automated to ensure that the conditioning vessel 110 and the reaction vessel 140 enter the test initiation mode safely, and without requiring additional user input or intervention. The example corrosion testing system 100 can then automatically transition to the test initiation mode followed by the corrosion test in progress and test termination modes. Upon completion, the reaction vessel 140 is automatically unsealed to expose the shaft. The user can further retrieve the coupon(s) for further analysis. Subsequently, the user can initiate cleaning mode, utilizing the available function in the interface of the control system 106. Once the cleaning mode is done, the instrument will enter ready mode again and will be set to start another test. During any stage of the test, if an emergency occurs, such as a sudden shift in pressure or temperature, the system shall initiate emergency mode. Additionally, the user shall be able to stop the test by enforcing emergency shutdown mode at any point during the test.

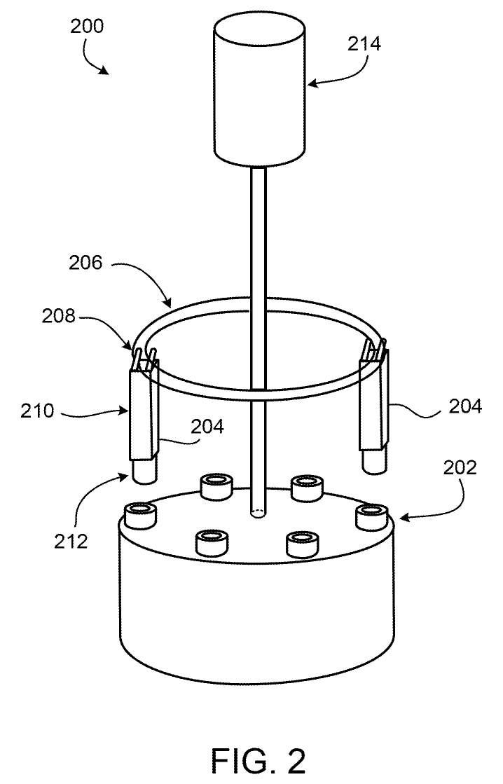

FIG. 2 is a schematic front view of an example sealing system 200 that can be used in the example corrosion testing system of FIG. 1, for example, in the example sealing system 150 of FIG. 1. The example sealing system 200 is used to engage fasteners on a vessel lid 202 to seal the vessel lid 202 to a vessel. The example sealing system 200 includes one or more locking devices 204 (two shown) arranged on and supported by a railway 206 positioned adjacent to (for example, just above) the vessel lid 202. The railway 206 of the example sealing system 200 has a circular shape, but the shape of the railway 206 can vary. For example, the railway 206 can have a shape that generally follows a pattern of the fasteners on the vessel lid 202. The locking devices 204 can include rollers 208, such as wheels, to allow controlled translation of the locking devices 204 along the railway 206. The locking devices 204 are controlled to move along the railway 206 and align with one or more of the fasteners on the vessel lid 202 in order to engage with the fasteners and securely fasten or unfasten the fasteners. In the example sealing system 200 of FIG. 2, the locking devices 204 include a torque body 210 and a bolt fastening portion 212 with a bolt engagement portion configured to engage with a fastener on the vessel lid 202. The torque body 210 drives the bolt fastening portion 212 to rotate when engaged with a bolt in a fastening direction or unfastening direction. In some examples, the bolt fastening portion 212 includes a key link, such as a hex-shaped key link, for engaging a hex-shape bolt head of the fastener. The example sealing system 200 of FIG. 2 also includes a motor 214 for driving and controlling rotation of a rotatable shaft, for example, a shaft connected to the fluid mixer 130 of the conditioning assembly 102 or the primary electrode 174 of the reaction assembly 104 of FIG. 1. In some implementations, the example sealing system 200 also includes a separate motor connected to the locking devices 204, the railway 206, or both, to drive translation of the locking devices 204 along the railway 206.

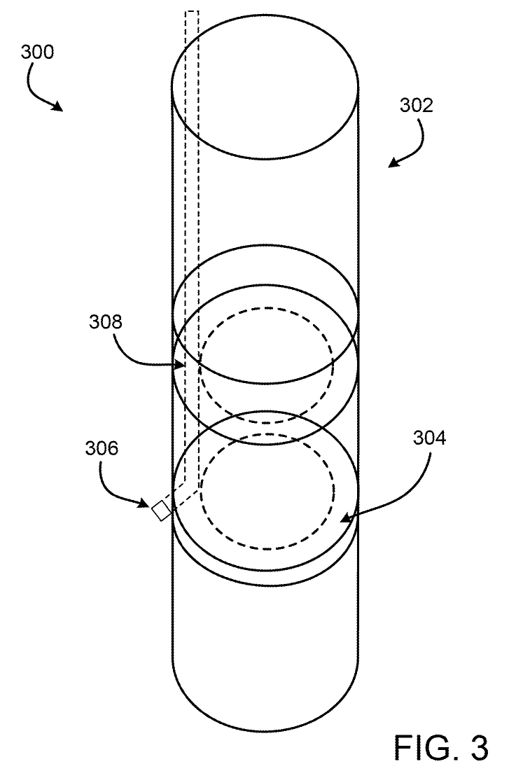

FIG. 3 is a partial schematic perspective view of an example primary electrode 300 that can be used in the primary electrode 174 of the example corrosion testing system 100 of FIG. 1. The example primary electrode 300 is the same as the example primary electrode 174 of FIG. 1, and includes a rotatable shaft 302 that supports a coupon 304 on the shaft 302. In some implementations, the primary electrode 300 incorporates a pH probe 306 housed within a perforated cylindrical portion 308 of the shaft 302. The perforated portion 308 and pH probe 306 can measure the pH of the environment near the surface of the coupon 304.

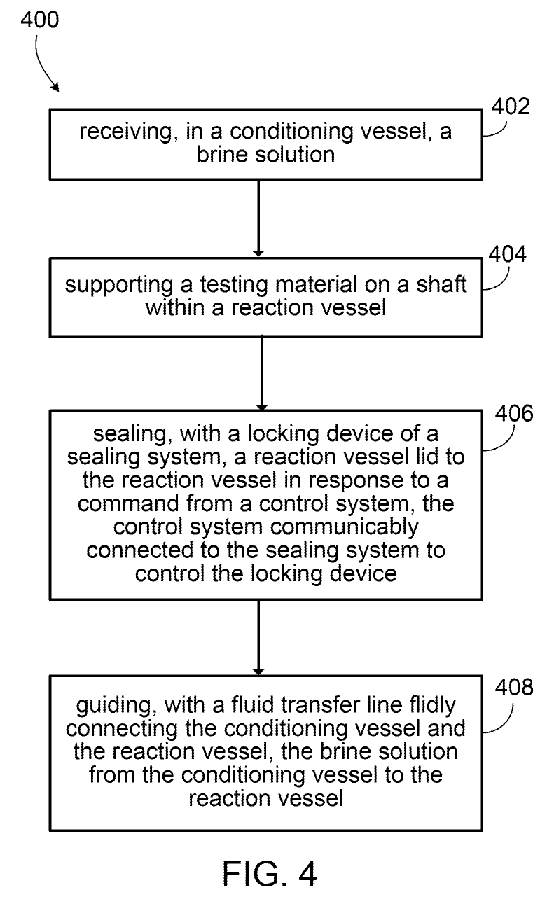

FIG. 4 is a flowchart describing an example method 400 for corrosion testing a material, for example, performed by the example corrosion testing system 100 of FIG. 1. At 402, a brine solution is received in a conditioning vessel. At 404, a testing material is supported on a shaft within a reaction vessel. At 406, a locking device of a sealing system seals a reaction vessel lid to the reaction vessel in response to a command from a control system. The control system is communicably connected to the sealing system to control the locking device. At 408, a fluid transfer line guides the brine solution from the conditioning vessel to the reaction vessel.

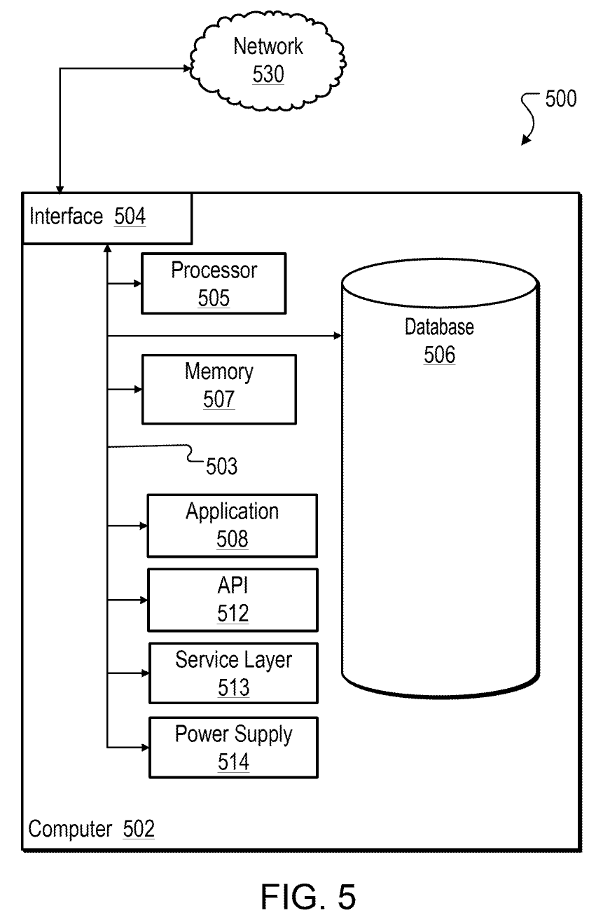

FIG. 5 is a block diagram of an example computer system 500 used to provide computational functionalities associated with described algorithms, methods, functions, processes, flows, and procedures described in the present disclosure, according to some implementations of the present disclosure. For example, the example computer system 500 can be used in the control system 106 of the example corrosion testing system 100 of FIG. 1. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface’s hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

### Examples

In a first aspect, an automated corrosion testing system comprises a conditioning vessel at least partially enclosing a first interior volume, a conditioning vessel lid configured to connect to the conditioning vessel and seal the conditioning vessel, a reaction vessel at least partially enclosing a second interior volume, a reaction vessel lid configured to connect to the reaction vessel and seal the reaction vessel, a fluid transfer line fluidly connecting the conditioning vessel to the reaction vessel, the fluid transfer line configured to guide a flow of a fluid from the conditioning vessel to the reaction vessel, a sealing system comprising a locking device configured to couple the reaction vessel lid to the reaction vessel, and a control system communicably connected to the sealing system and the fluid transfer line, the control system configured to activate the sealing system and control the flow of fluid through the fluid transfer line.

In a second aspect according to the first aspect, the sealing system comprises a railway supporting the locking device adjacent to the reaction vessel lid, the locking device configured to translate along the railway.

In a third aspect according to the second aspect, the locking device comprises a bolt fastener comprising rollers engaged with the railway, the bolt fastener configured to engage at least one bolt on the reaction vessel lid to seal the reaction vessel lid to the reaction vessel.

In a fourth aspect according to the second aspect or the third aspect, the sealing system comprises a motor connected to the locking device and configured to drive translation and operation of the locking device.

In a fifth aspect according to any one of the first aspect to the fourth aspect, the sealing system comprises a second railway and a second locking device, the second railway supporting the second locking device adjacent to the conditioning vessel lid, the second locking device configured to translate along the second railway.

In a sixth aspect according to the fifth aspect, the second locking device comprises a bolt fastener comprising rollers engaged with the second railway, the bolt fastener configured to engage at least one bolt on the conditioning vessel lid to seal the conditioning vessel lid to the conditioning vessel.

In a seventh aspect according to any one of the first aspect to the sixth aspect, the automated corrosion testing system further comprises a brine makeup system fluidly connected to the conditioning vessel and communicably connected to the control system, the brine makeup system comprising a plurality of fluid vessels configured to hold brine components, and the control system configured to determine a brine composition and control a flow of the brine components according to the determined brine composition to the conditioning vessel.

In an eighth aspect according to any one of the first aspect to the seventh aspect, the automated corrosion testing system further comprises a pH adjustment system fluidly connected to the reaction vessel and communicably connected to the control system, the pH adjustment system comprising a first vessel for storing an acid and a second vessel for storing a base, the control system configured to control a flow of at least one of the acid or the base to the reaction vessel.

In a ninth aspect according to any one of the first aspect to the eighth aspect, the automated corrosion testing system further comprises a gas discharge system fluidly connected to the reaction vessel and communicably connected to the control system, the gas discharge system comprising a scrubber configured to filter a discharged gas from the reaction vessel.

In a tenth aspect according to any one of the first aspect to the ninth aspect, the automated corrosion testing system further comprises a heat jacket at least partially surrounding the reaction vessel and communicably connected to the control system, the heat jacket configured to increase a temperature of the fluid in the reaction vessel.

In an eleventh aspect, a method for corrosion testing a material comprises receiving, in a conditioning vessel, a brine solution, supporting a testing material on a shaft within a reaction vessel, sealing, with a locking device of a sealing system, a reaction vessel lid to the reaction vessel in response to a command from a control system, the control system communicably connected to the sealing system to control the locking device, and guiding, with a fluid transfer line fluidly connecting the conditioning vessel and the reaction vessel, the brine solution from the conditioning vessel to the reaction vessel.

In a twelfth aspect according to the eleventh aspect, sealing the reaction vessel lid to the reaction vessel comprises coupling fasteners of the reaction vessel lid to the reaction vessel with the locking device, the locking device comprising a locking profile for engaging the fasteners.

In a thirteenth aspect according to the twelfth aspect, the sealing system comprises a railway supporting the locking device adjacent to the reaction vessel lid, and coupling the fasteners with the locking device comprises translating the locking device along the railway to the fasteners and engaging the fasteners.

In a fourteenth aspect according to the thirteenth aspect, the method comprises driving translation of the locking device with a motor connected to the locking device.

In a fifteenth aspect according to any one of the eleventh aspect to the fourteenth aspect, the method further comprises sealing, with a second locking device of the sealing system, a conditioning vessel lid to the conditioning vessel in response to a second command from the control system, the control system communicably connected to the sealing system to control the second locking device.

In a sixteenth aspect according to the fifteenth aspect, sealing the conditioning vessel lid to the conditioning vessel comprises coupling fasteners of the conditioning vessel lid to the conditioning vessel with the second locking device, the sealing system comprising a second railway supporting the second locking device adjacent to the conditioning vessel lid, and coupling the fasteners with the second locking device comprises translating the second locking device along the second railway to the fasteners and engaging the fasteners with the second locking device.

In a seventeenth aspect according to any one of the eleventh aspect to the sixteenth aspect, the method further comprises determining, with the control system, a brine composition making up the brine solution, and generating, at a brine makeup system fluidly connected to the conditioning vessel and communicably connected to the control system, the brine solution.

In an eighteenth aspect according to any one of the eleventh aspect to the seventeenth aspect, the method further comprises determining, with a sensor communicably connected to the control system, a pH of the brine solution in the reaction vessel, and flowing, with a pH adjustment system fluidly connected to the reaction vessel and based on the determined pH of the brine solution, at least one of an acidic fluid or a base fluid to the brine solution in the reaction vessel.

In a nineteenth aspect according to any one of the eleventh aspect to the eighteenth aspect, the method further comprises filtering, with a gas discharge system fluidly connected to the reaction vessel and communicably connected to the control system, a discharged gas from the reaction vessel.

In a twentieth aspect, an automated corrosion testing system comprises a reaction vessel at least partially enclosing an interior volume, a reaction vessel lid configured to connect to the reaction vessel and seal the reaction vessel, a sealing system comprising a railway and a locking device supported on the railway adjacent to the reaction vessel lid, the sealing system configured to couple the reaction vessel lid to the reaction vessel, a control system communicably connected to the sealing system and configured to activate the sealing system.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. Various modifications may be made without departing from the spirit and scope of the disclosure. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. An automated corrosion testing system, comprising:
a conditioning vessel at least partially enclosing a first interior volume;
a conditioning vessel lid configured to connect to the conditioning vessel and seal the conditioning vessel;
a reaction vessel at least partially enclosing a second interior volume;
a reaction vessel lid configured to connect to the reaction vessel and seal the reaction vessel;
a fluid transfer line fluidly connecting the conditioning vessel to the reaction vessel, the fluid transfer line configured to guide a flow of a fluid from the conditioning vessel to the reaction vessel;
a sealing system comprising a locking device configured to couple the reaction vessel lid to the reaction vessel; and
a control system communicably connected to the sealing system and the fluid transfer line, the control system configured to activate the sealing system and control the flow of fluid through the fluid transfer line.

2. The automated corrosion testing system of claim 1, wherein the sealing system comprises a railway supporting the locking device adjacent to the reaction vessel lid, the locking device configured to translate along the railway.

3. The automated corrosion testing system of claim 2, wherein the locking device comprises a bolt fastener comprising rollers engaged with the railway, the bolt fastener configured to engage at least one bolt on the reaction vessel lid to seal the reaction vessel lid to the reaction vessel.

4. The automated corrosion testing system of claim 2, wherein the sealing system comprises a motor connected to the locking device and configured to drive translation and operation of the locking device.

5. The automated corrosion testing system of claim 1, wherein the sealing system comprises a second railway and a second locking device, the second railway supporting the second locking device adjacent to the conditioning vessel lid, the second locking device configured to translate along the second railway.

6. The automated corrosion testing system of claim 5, wherein the second locking device comprises a bolt fastener comprising rollers engaged with the second railway, the bolt fastener configured to engage at least one bolt on the conditioning vessel lid to seal the conditioning vessel lid to the conditioning vessel.

7. The automated corrosion testing system of claim 1, further comprising a brine makeup system fluidly connected to the conditioning vessel and communicably connected to the control system, the brine makeup system comprising a plurality of fluid vessels configured to hold brine components, and the control system configured to determine a brine composition and control a flow of the brine components according to the determined brine composition to the conditioning vessel.

8. The automated corrosion testing system of claim 1, further comprising a pH adjustment system fluidly connected to the reaction vessel and communicably connected to the control system, the pH adjustment system comprising a first vessel for storing an acid and a second vessel for storing a base, the control system configured to control a flow of at least one of the acid or the base to the reaction vessel.

9. The automated corrosion testing system of claim 1, further comprising a gas discharge system fluidly connected to the reaction vessel and communicably connected to the control system, the gas discharge system comprising a scrubber configured to filter a discharged gas from the reaction vessel.

10. The automated corrosion testing system of claim 1, further comprising a heat jacket at least partially surrounding the reaction vessel and communicably connected to the control system, the heat jacket configured to increase a temperature of the fluid in the reaction vessel.

11. A method for corrosion testing a material, the method comprising:
receiving, in a conditioning vessel, a brine solution;
supporting a testing material on a shaft within a reaction vessel;
sealing, with a locking device of a sealing system, a reaction vessel lid to the reaction vessel in response to a command from a control system, the control system communicably connected to the sealing system to control the locking device; and
guiding, with a fluid transfer line fluidly connecting the conditioning vessel and the reaction vessel, the brine solution from the conditioning vessel to the reaction vessel.

12. The method of claim 11, wherein sealing the reaction vessel lid to the reaction vessel comprises coupling fasteners of the reaction vessel lid to the reaction vessel with the locking device, the locking device comprising a locking profile for engaging the fasteners.

13. The method of claim 12, wherein the sealing system comprises a railway supporting the locking device adjacent to the reaction vessel lid, and coupling the fasteners with the locking device comprises translating the locking device along the railway to the fasteners and engaging the fasteners.

14. The method of claim 13, comprising driving translation of the locking device with a motor connected to the locking device.

15. The method of claim 11, further comprising sealing, with a second locking device of the sealing system, a conditioning vessel lid to the conditioning vessel in response to a second command from the control system, the control system communicably connected to the sealing system to control the second locking device.

16. The method of claim 15, wherein sealing the conditioning vessel lid to the conditioning vessel comprises coupling fasteners of the conditioning vessel lid to the conditioning vessel with the second locking device, the sealing system comprising a second railway supporting the second locking device adjacent to the conditioning vessel lid, and coupling the fasteners with the second locking device comprises translating the second locking device along the second railway to the fasteners and engaging the fasteners with the second locking device.

17. The method of claim 11, further comprising:
determining, with the control system, a brine composition making up the brine solution; and
generating, at a brine makeup system fluidly connected to the conditioning vessel and communicably connected to the control system, the brine solution.

18. The method of claim 11, further comprising:
determining, with a sensor communicably connected to the control system, a pH of the brine solution in the reaction vessel; and
flowing, with a pH adjustment system fluidly connected to the reaction vessel and based on the determined pH of the brine solution, at least one of an acidic fluid or a base fluid to the brine solution in the reaction vessel.

19. The method of claim 11, further comprising filtering, with a gas discharge system fluidly connected to the reaction vessel and communicably connected to the control system, a discharged gas from the reaction vessel.

20. An automated corrosion testing system, comprising:
a reaction vessel at least partially enclosing an interior volume;
a reaction vessel lid configured to connect to the reaction vessel and seal the reaction vessel;
a sealing system comprising a railway and a locking device supported on the railway adjacent to the reaction vessel lid, the sealing system configured to couple the reaction vessel lid to the reaction vessel; and
a control system communicably connected to the sealing system and configured to activate the sealing system.
